(19) United States
(12) Patent Application Publication
(10) Pub. No.: US 2003/0061959 A1
(43) Pub. Date: Apr. 3, 2003

(54) Merchandising system

(75) Inventor: Allen E. Johnson, Hartford, WI (US)

Correspondence Address: FOLEY & LARDNER, 777 EAST WISCONSIN AVENUE, MILWAUKEE, WI, 53202, US

(73) Assignee: DCI Marketing, Inc.

(21) Appl. No.: 10/225,470

(22) Filed: Aug. 21, 2002

Related U.S. Application Data
(63) Continuation of application No. 60/314,009, filed on Aug. 21, 2001.

(51) Int. Cl. B60S 13/02

(52) U.S. Cl. 104/44

(57) ABSTRACT

A merchandising and/or display system for displaying objects such as vehicles is disclosed. The merchandising system may include a base and a member coupled to the base, configured to support the vehicle and to move between a first and second position. The first position is configured to allow placement of the vehicle on the member and the second position is configured to display the vehicle.

### CROSS-REFERENCE TO RELATED PATENT APPLICATIONS

The present application claims the benefit of U.S. Provisional Patent Application No. 60/314,009 (“DISPLAY SYSTEM”) filed Aug. 21, 2001 under 35 U.S.C. § 119, incorporated in the present application by reference.

### BACKGROUND OF THE INVENTION

The present invention relates to a merchandising system for an object. The present invention more specifically relates to a merchandising system (such as a display system) for a vehicle or the like providing for support of the vehicle on the merchandising system.

It is known to provide for a merchandising system that may be used for vehicles and the like. Such known merchandising systems do not realize certain advantageous features (and/or combinations of features).

It would be advantageous to provide a merchandising system that provides for the secure support of an object, including vehicles, motorcycles, recreational vehicles and the like. It would further be advantageous to provide a merchandising system that allows the object to be rotated for display and/or held in a fixed position. It would further be advantageous to provide a merchandising system which is easily adjustable and reconfigurable for a variety of different sized and shaped objects. It would further be advantageous to provide a merchandising system that provides selective adjustability for various objects (e.g. an interface and arrangements of interfaces may be used to accommodate a variety of different objects having different mounting or support points). It would further be advantageous to provide a merchandising system that allows for loading, unloading, or placing an object on the merchandising system without lifting or requiring additional equipment such as hoists, lifts, etc.

It would be desirable to provide a merchandising system that provides any one or more of these or other advantageous features.

### SUMMARY OF THE INVENTION

The present invention relates to a merchandising system. The merchandising system comprises a base and a member coupled to the base, configured to support the vehicle and to move between a first position and second position. The first position is configured to allow placement of the vehicle on the member and the second position is configured to display the vehicle.

The present invention also relates to a merchandising system for displaying a vehicle in an environment having a floor. The merchandising system comprises a base and a first ramp coupled to the base. The first ramp is configured to move between a first position having a portion of the first ramp near the floor and a second position having a portion of the first ramp removed from the floor.

The present invention further relates to a merchandising system for an article. The merchandising system comprises means for supporting an article. The means for supporting the article is configured to move between a first position to allow for placement of the article on the merchandising system and a second position to allow for the display of the article.

### BRIEF DESCRIPTION OF THE DRAWINGS

FIG. 1 is a perspective view of a merchandising system according to an exemplary embodiment.

FIG. 2 is a perspective view of the merchandising system shown in FIG. 1.

FIG. 3 is a side elevation view of a merchandising system according to an exemplary embodiment.

FIG. 4 is a side elevation view of the merchandising system.

FIG. 5 is a side elevation view of the merchandising system.

FIG. 6 is an exploded perspective view of a merchandising system according to an exemplary embodiment.

FIG. 7 is an exploded perspective view of a base for use with a merchandising system according to an exemplary embodiment.

FIG. 8 is an exploded perspective view of an interface for use with a merchandising system according to an exemplary embodiment.

FIG. 9 is a perspective view of a pivot and retainer assembly for use with a merchandising system according to an exemplary embodiment.

FIG. 10 is a perspective view of a pivot and retainer assembly for use with a merchandising system according to an exemplary embodiment.

FIG. 11 is an exploded perspective view of a support for use with a merchandising system according to an exemplary embodiment.

FIG. 12 is an exploded perspective view of a retainer assembly for use with a merchandising system according to an exemplary embodiment.

FIG. 13 is a perspective view of a merchandising system according to an alternative embodiment.

FIG. 14 is a perspective view of a merchandising system according to an alternative embodiment.

FIG. 15 is a perspective view of a merchandising system according to an alternative embodiment.

FIG. 16 is an exploded perspective view of a support for use with a merchandising system according to an alternative embodiment.

FIG. 17 is a schematic view of a merchandising system according to an alternative embodiment.

### DETAILED DESCRIPTION OF THE PREFERRED EMBODIMENTS

Referring to the FIGURES, exemplary embodiments of a merchandising system are shown. The merchandising system may provide for the display, presentation and storage of a wide variety of objects, articles, or products such as vehicles, motorcycles, automobiles, snowmobiles, all-terrain vehicles, products, etc. The merchandising system may be used in environments such as display rooms, show rooms, etc.

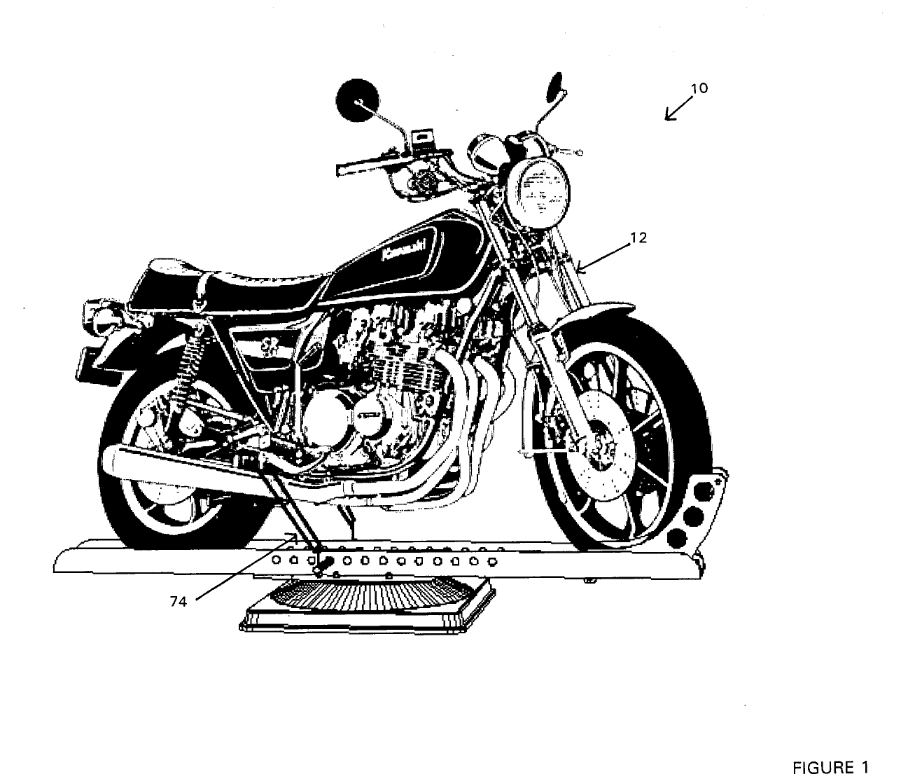

As shown in the FIGURES, the merchandising system advantageously allows different-sized objects to be displayed on a single merchandising system. A merchandising system may be reconfigured to accommodate a number of different sizes, shapes and configurations of objects while not requiring significant time or effort for accomplishing the reconfiguration. Additionally, the merchandising systems shown are intended to allow the placement, mounting, display, and/or storage of objects without lifting or requiring additional equipment such as hoists, lifts, etc. According to one particularly preferred embodiment, a moveable ramp is provided to allow an object to be moved on or off of the merchandising system. According to a particularly preferred embodiment shown in FIG. 1, the object (vehicle) is a motorcycle.

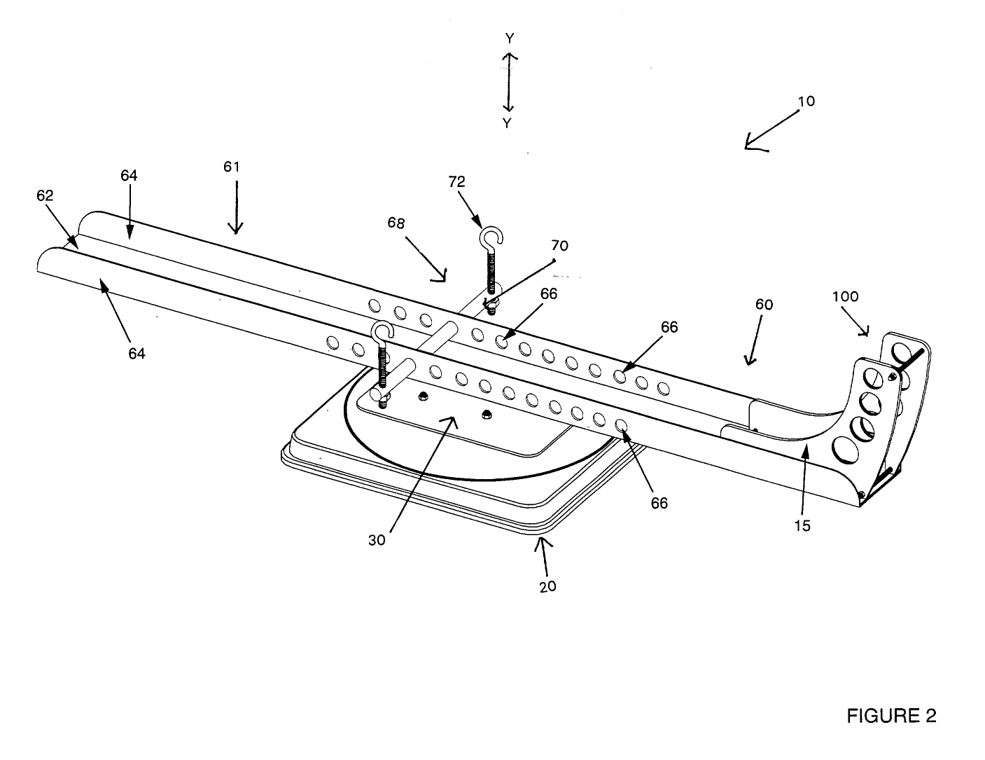

Referring to FIGS. 1 through 12, an exemplary embodiment of a merchandising system 10 for an object 12 is shown. Merchandising system 10 may comprise a base 20, an interface 30 and a support 60 (see FIG. 2).

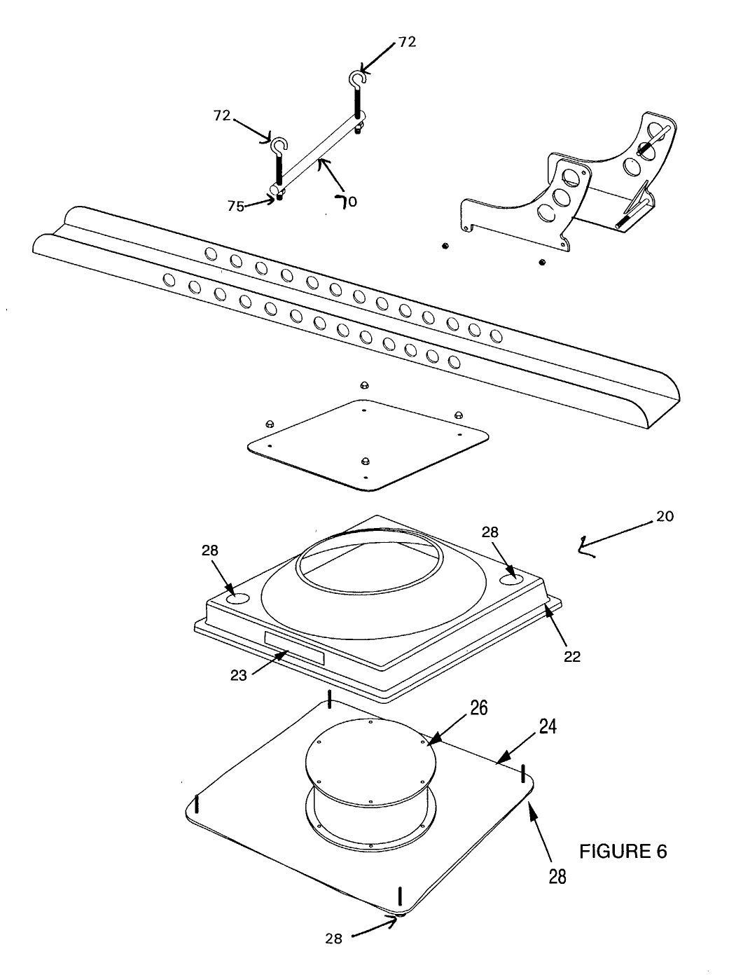

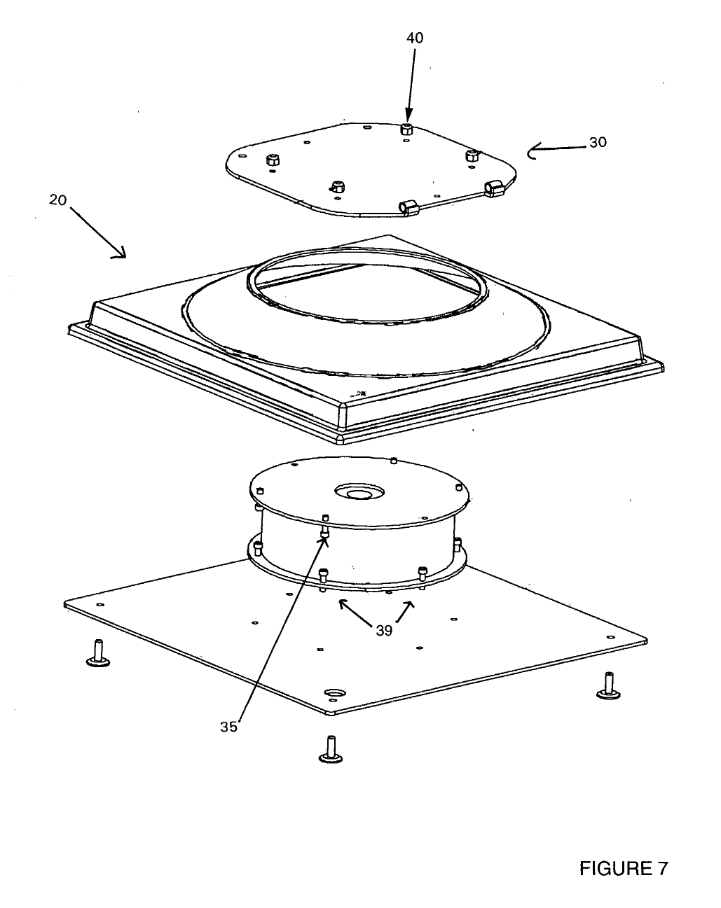

As shown in FIGS. 6 and 7, base 20 (which may be a platform, stand, etc.) may generally comprise a housing 22, a plate 24, a motor 26, and one or more feet 28 (e.g., supports, skids, leveling feet, rollers, etc.).

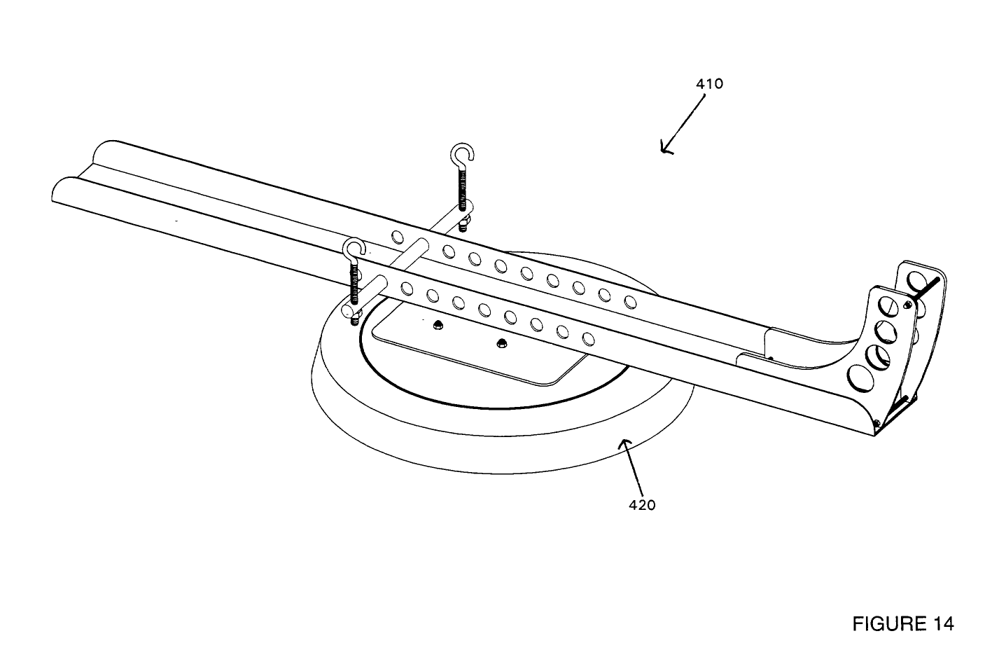

Housing 22 and/or plate 24 of base 20 generally defines the outer perimeter of base 20. As shown in FIG. 6, housing 22 and/or plate 24 may be a generally square shape. According to alternative embodiments, the housing and/or plate may be any desired shape, such as rectangular, circular, triangular, etc., or combinations of various shapes. According to one alternative embodiment shown in FIG. 14, base 420 may have a circular shape.

As shown in FIG. 6, housing 22 may have indicia 23 (e.g. lettering, graphics, text, etc.) disposed on various surfaces or edges of housing 22. Housing 22 may be provided with a variety of other surface treatments, such as texturing, lettering, designs, artwork, etc.

In an effort to enhance visual appeal of the object, the merchandising system may move (e.g. rotate, etc.) the object relative to the base. According to an exemplary embodiment shown in FIG. 2, the object rotates around a central axis of base 20 (shown as line Y-Y). (The rotation or movement of the object may add to the visual appeal of the object by allowing the object to be observed more fully and conveniently.)

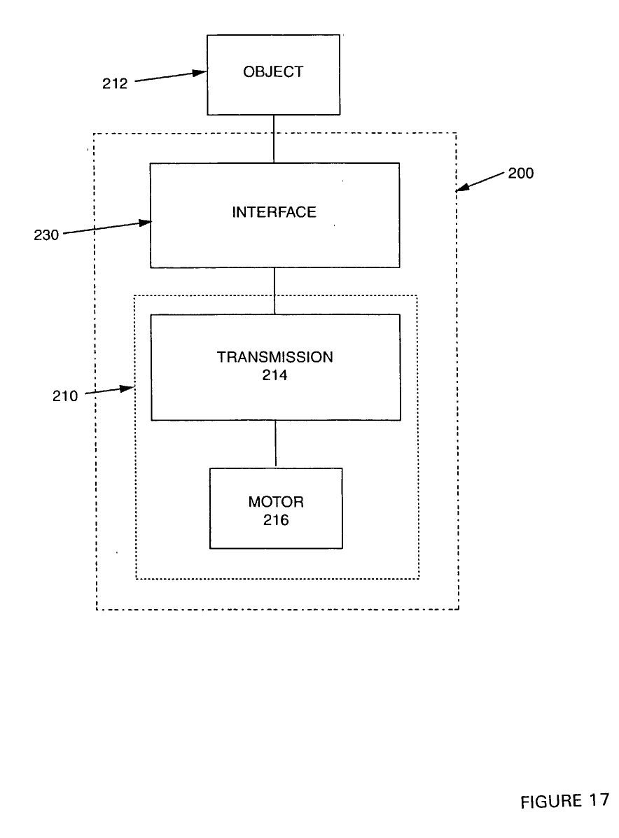

To provide rotation (or movement), motor 26 may be provided in base 20 of merchandising system 10 (see FIGS. 6 and 7). Motor 26 may be coupled to housing 22 and/or plate 24 with a variety of fasteners, including mechanical fasteners, screws, bolts, adhesives, etc. (shown as bolts 39). Motor 26 allows for the powered movement or rotation of object 12. According to a particularly preferred embodiment, the motor may be commercially available under the name “Turn-Plate” (Model No. U 5000) from Outwater Plastic Industries of Wood-Ridge, New Jersey. According to other alternative embodiments, the motor may be of any conventional type of motor capable of rotating the object. The merchandising system may use a “direct” drive (the motor may have a “direct” drive link or coupling with the object by a rigid connection between the motor and the interface/object). According to alternative embodiments, the merchandising system may use an “indirect” drive (i.e. the motor may be coupled to the object via other drive assemblies such as belts, gear trains, transmissions, piston/rocker or cam/eccentric action etc.) that may allow for adjustment and/or adaptation of movement (e.g. linear or eccentric or rotation or some combination) for a particular application. For example, as shown in FIG. 17, a merchandising system 200 for the display of an object 212 may include a drive system (shown as drive assembly 210). Drive assembly 210 may be provided to rotate object 212. Drive assembly 210 may include a transmission 214 and a motor 216. Interface 230 may be coupled to drive assembly 210 in order to attach or couple object 212 to merchandising system 200. The use of a suitable drive assembly or drive system may allow for the use of lower power motors, providing variable rotation speed of the displayed product, translating or providing linear movement of the object, etc.

In an effort to further enhance the visual or aesthetic appeal of the object (or objects) upon merchandising system 10, base 20 may be provided with various lights or lighting effects (shown as lights 28). Such lighting effects may be used to illuminate or feature the object or to illuminate various features of the object.

Interface 30 may be provided on or coupled to base 20. According to a particularly preferred embodiment shown in FIG. 7, interface 30 is coupled to motor 26 via fasteners 35. According to various alternative embodiments, the interface may be omitted, with the support coupled directly to the base.

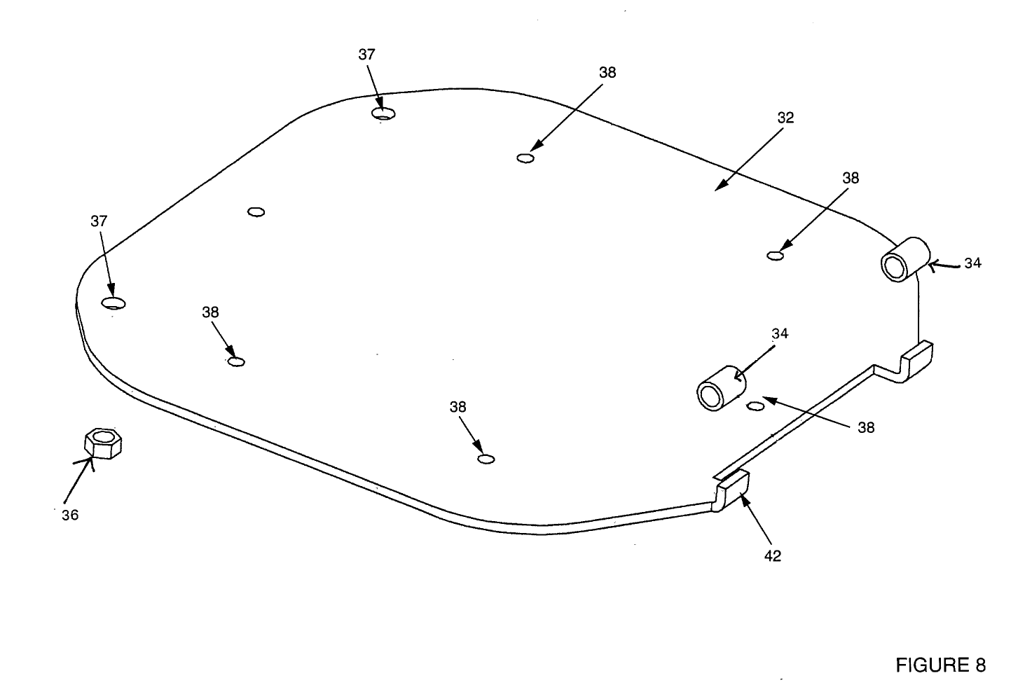

As shown in FIG. 8, interface 30 may comprise plate 32, one or more sleeves 34 (shown as cylindrical sleeves), one or more fasteners 36 (shown as nuts), apertures 37 and apertures 38. Interface 30 may be coupled to motor 26 via fasteners (shown in FIG. 7 as bolts 35 and nuts 40) provided through apertures 38.

One or more sleeves 34 may be provided on plate 32. According to a particularly preferred embodiment shown in FIG. 8, sleeves 34 are provided on one edge of plate 32, spaced apart by approximately seven inches. According to various alternative embodiments, one or more sleeves may be used having a variety of spacings. Sleeves 34 may be attached to prongs 42 by fasteners, welding, adhesives, etc. According to an alternative embodiment, sleeves may be formed in the plate by forming, folding, bending, etc. a portion of material into a suitable shape. According to various exemplary embodiments, sleeves 34 form a portion of a hinge, pivot assembly or pivot point to allow selective movement of support 60.

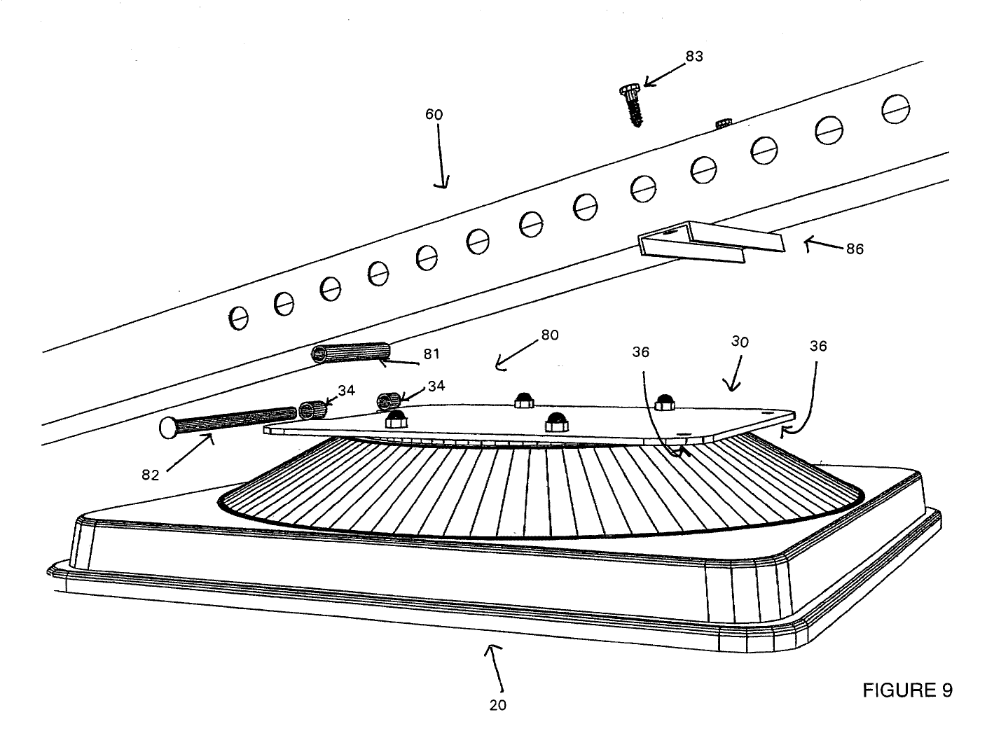

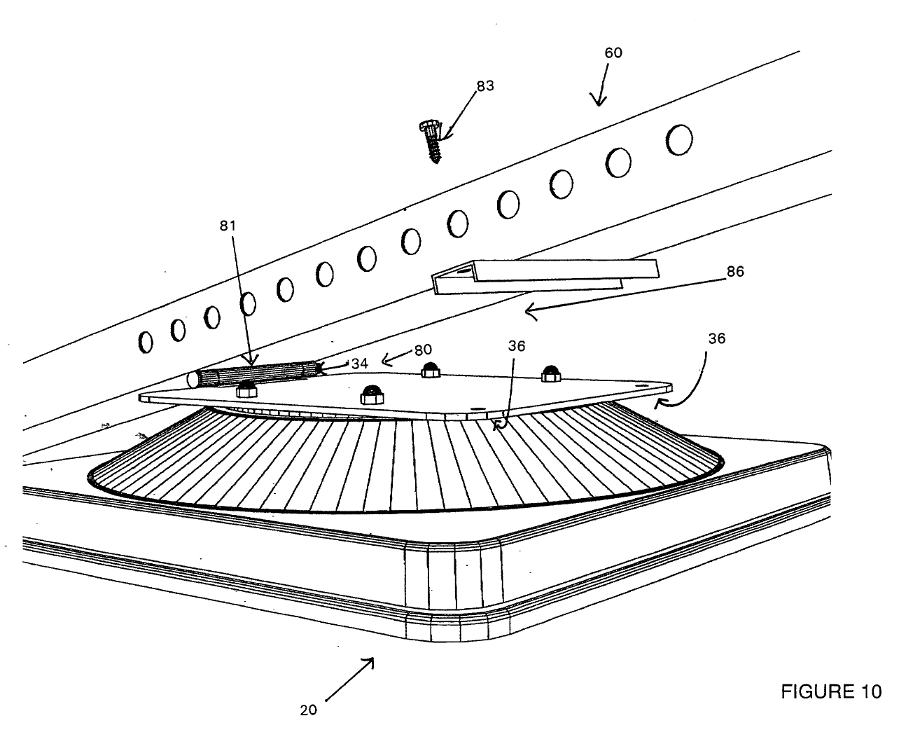

One or more fasteners 36 (shown as nuts) may be provided on a bottom side of plate 32. According to a particularly preferred embodiment, fasteners 36 are welded to plate 32. Fasteners 36 are provided to coact with a fastener assembly 86 to selectively stop movement of support 60 relative to base 20 (see FIGS. 9 and 10).

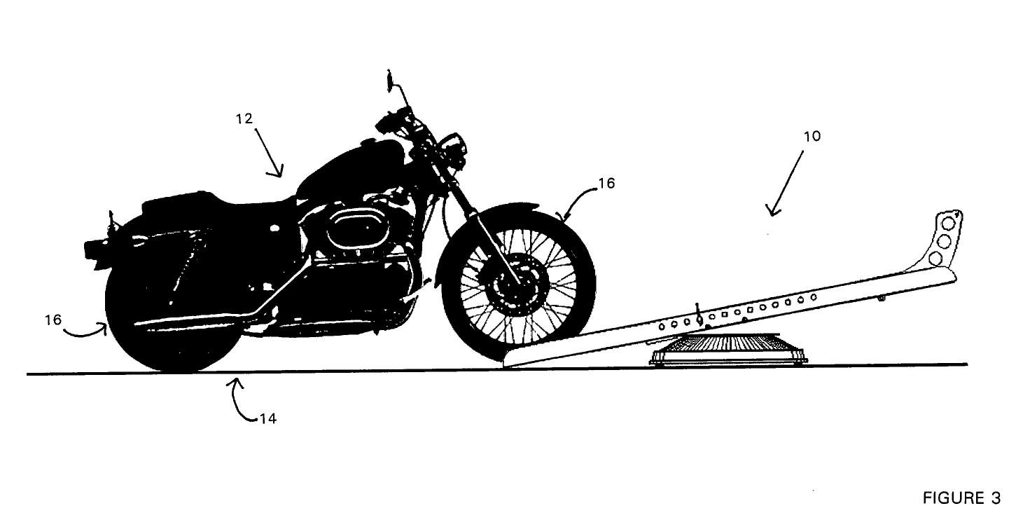

Referring back to FIG. 2, merchandising system 10 may further comprise a support 60 (e.g. support structure, ramp, frame, bracket, etc.). Support 60 may be attached to interface 30 by using a variety of different fasteners including pins, hinges, pivots, screws, rivets, welding, etc. (see, e.g., FIGS. 9 and 10). According to various exemplary embodiments, the support is configured to be moveable with respect to the base. According to one particularly preferred embodiment shown in FIGS. 3 to 5, support 60 is configured to pivot with respect to base 20 (including when object 12 is placed on merchandising system 10).

Support 60 is generally of sufficient length and width to allow appropriate support and display of an article such as a vehicle, motorcycle, recreational vehicle and the like. According to one exemplary embodiment shown in FIG. 1, support 60 is long enough to support two wheels of a motorcycle (e.g. object 12).

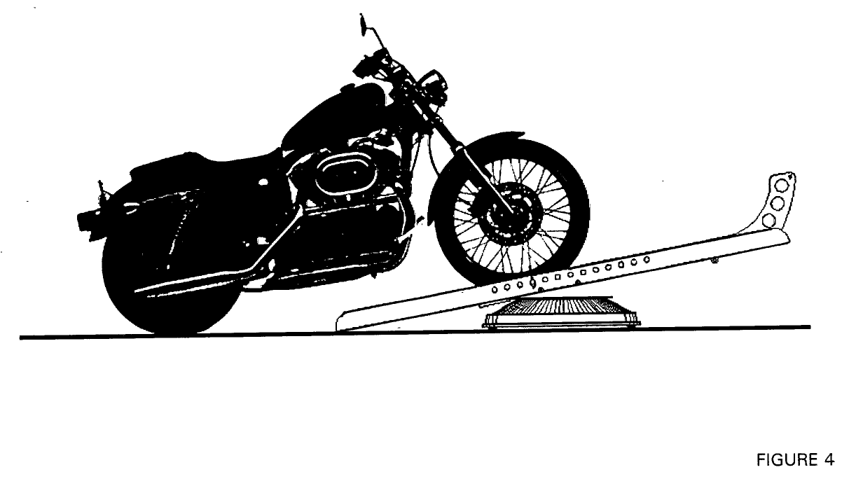

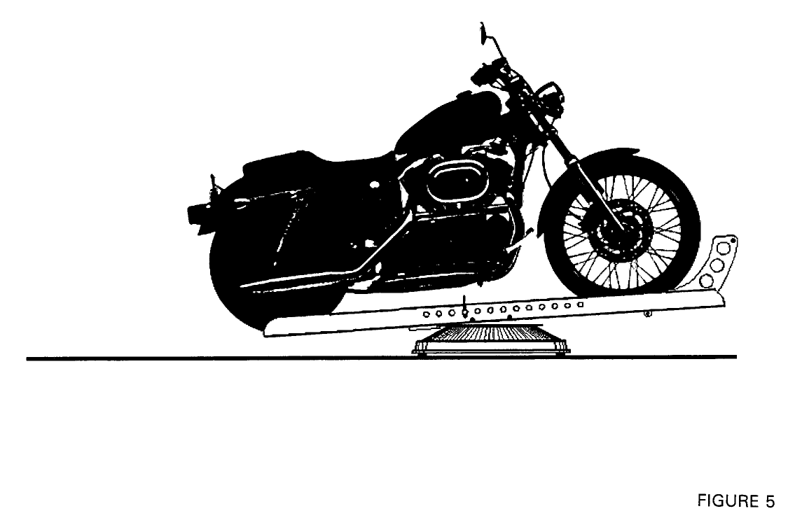

As shown in FIGS. 1 and 3 to 5, merchandising system 10 advantageously allows object 12 to be placed on support 60 by rolling object 12 onto support 60. In FIG. 3, support 60 is shown in a first position (e.g. a loading, placement or installation position). In the first position, support 60 may be near or touching floor 14 allowing wheels 16 of object 12 to roll from floor 14 to support 60. As object 12 is moved forward along support 60 (see intermediate positions shown in FIGS. 4 and 5), support 60 gradually rotates toward a second position (e.g. a storage or display position) shown in FIG. 1.

Support 60 may provide a selectively adaptable and/or reconfigurable interface for one or more variously sized articles or objects such as a vehicle or motorcycle.

According to one exemplary embodiment shown in FIG. 2, support 60 may comprise a platform 61 (e.g. panel, horizontal panel, ramp, rail, track, frame, bracket, etc.) a first retainer assembly 68 and a second retainer assembly 100. According to one exemplary embodiment, a hinge or pivot assembly and a fastener assembly are provided between support 60 and base 20. According to the particularly preferred embodiment shown in FIG. 9, a hinge or pivot assembly 80 and a fastener assembly 86 may be provided between support 60 and interface 30 (which is coupled to base 20).

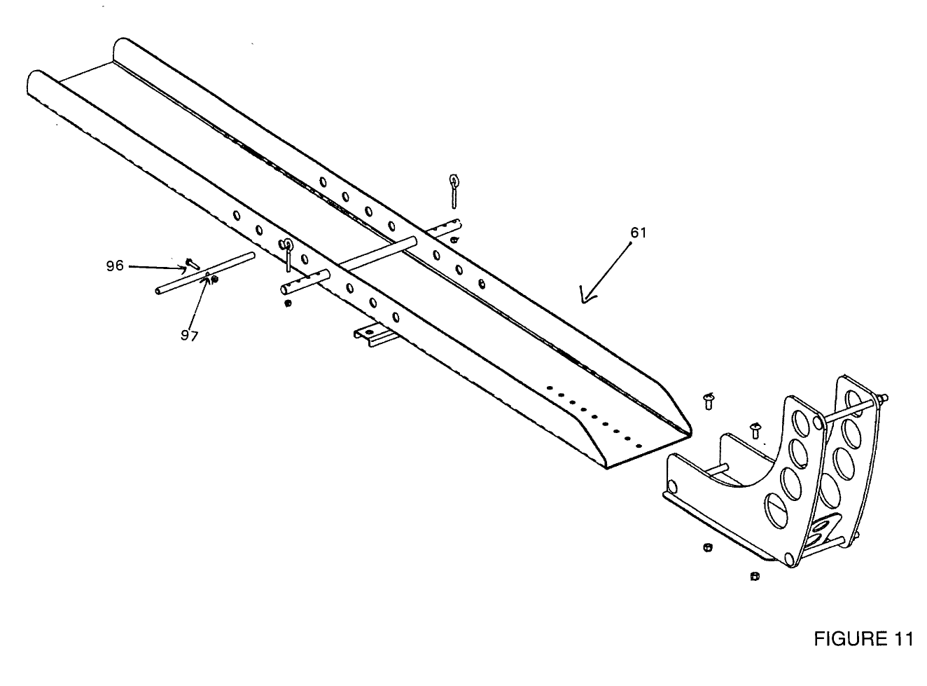

As shown in FIGS. 2 and 11, platform 61 may be generally constructed and assembled from horizontal and vertical panels (shown as panels 62 and 64). Panels 62 and 64 can be formed from a single piece of material and then formed or bent to shape. Alternatively, panels 62 and 64 may be fastened together with a variety of different fasteners including screws, rivets, welding, etc.

Platform 61 may be provided with a plurality of apertures. According to a particularly preferred embodiment shown in FIG. 2, a number of apertures 66 are provided in panels 64. Apertures 66 may provide convenient mounting areas or points for first retainer assembly 68.

First retainer assembly 68 may comprise a cross member 70 (e.g. member, rod, shaft, tube, bar, etc.), one or more hooks 72 (e.g. fasteners, eye-bolts, notches, mounting points, etc.), and one or more fastening elements or webs 74 (e.g., web or strap). As shown in FIG. 6, hooks 72 may be provided on ends of cross member 70. As shown in FIG. 11, hooks may be provided in a number of locations along the cross member. Web 74 may then be coupled to hook 72. Webs 74 may be provided to assist securing object 12 (see FIG. 1).

Web 74 may be attached to a suitable portion of the object (e.g. foot pegs, various locations of a frame, handle bars, etc.) (shown in FIG. 1 as a foot peg). Hook 72 may be used to secure web 74 to an attachment location on the object.

Web 74 may be a pliable or flexible material suitable to provide sufficient holding power when attached to the object. Web 74, according to a particularly preferred embodiment, may be constructed from nylon webbing. The web may further include two apertures on the ends of web surrounded by a reinforcing washer to be connected to the hook.

Hook 72 may be attached to web 74. According to a particularly preferred embodiment, hook 72 is held in place on a bottom side of cross member 70 with fastener 75 (shown as a nut in FIG. 6). Fastener 75 attaches to a threaded portion on hook 72. As fastener 75 is tightened, hook 72 increases the holding force on web 74, thereby holding the object more firmly in place.

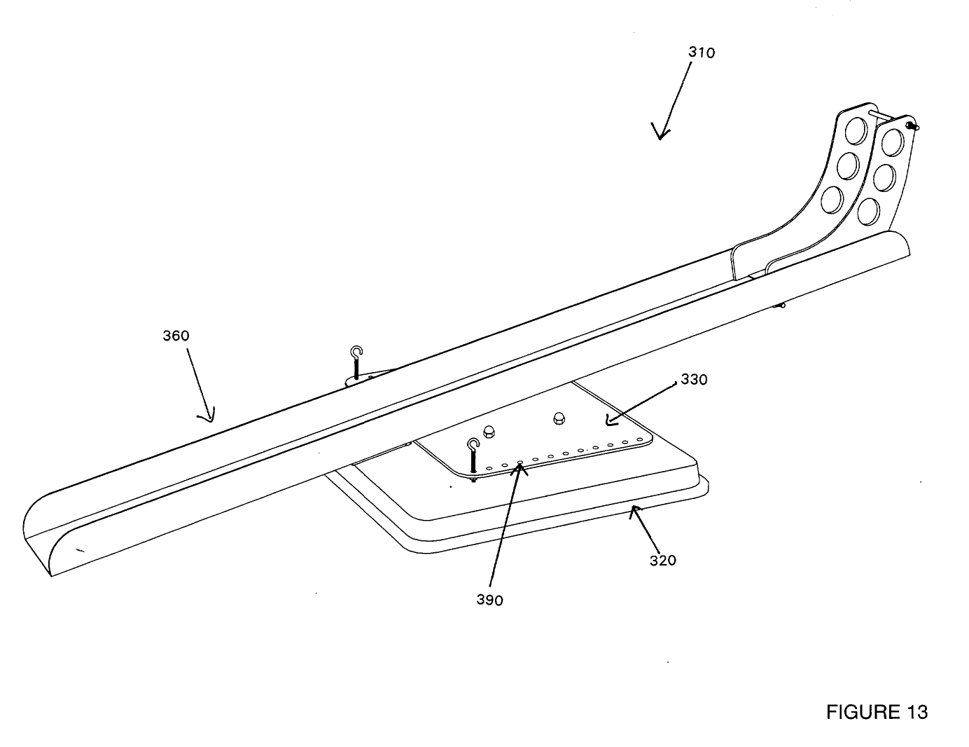

According to one alternative embodiment shown in FIG. 13, an interface 330 may be provided with a plurality of mounting points 390 (e.g., slots, apertures, etc.).

Mounting points 390 may be provided in a variety of locations, directions and orientations. Mounting points 390 preferably provide convenient mounting areas for webs (e.g., tie-downs, straps, etc.). The webs assist in the support of an object, such as a motorcycle, by holding webs taut to each side of a portion of the object (such as a motorcycle foot rest).

According to various exemplary embodiments, apertures may be arranged in various orientations and configurations to provide a variety of adjustment positions and/or support points for the first retainer.

As shown in FIGS. 9 and 10, a hinge or pivot assembly 80 and a fastener assembly 86 may be provided between support 60 and base 20. Pivot assembly 80 is coupled between support 60 and base 20 in a manner that allows support 60 to move (e.g. rotate, tilt, raise, lower, pivot, etc.) to allow mounting, rolling, sliding, placement, etc. of object 12 onto merchandising system 10. According to a particularly preferred embodiment shown in FIGS. 9 and 10, pivot assembly 80 comprises sleeves 34, sleeve 81 and pin 82. Pin 82 is configured to fit into or through sleeves 34 and 81, to couple support 60 to base 20 while still allowing support 60 to pivot with respect to base 20. Sleeve 81 may be attached to support 60 with a variety of fasteners including welding, brackets, screws, mechanical fasteners, etc. According to a particularly preferred embodiment shown in FIG. 11, an alignment pin 96 may be provided through apertures provided in sleeve 81 and pin 82 (see aperture 97) in order secure pin 82 relative to sleeve 81 and prevent movement of pin 82.

Fastener assembly 86 may be provided between support 60 and base 20 at the opposite end of pivot assembly 80. Fastener assembly 86 provides for the selective movement and/or stopping movement of support 60. According to one particularly preferred embodiment shown in FIG. 9, fastener assembly 86 is provided to allow support 60 to return back to its original position (e.g., level, not tilted/fully resting on base 20) and secure support 60 in a fixed position (e.g., preventing support 60 from moving). According to one particularly preferred embodiment shown in FIGS. 9 and 10, fastener assembly 86 comprises one or more fasteners 83 (e.g. screws, bolts, nuts, mechanical fasteners, pins similar to pin 82, catches, etc.) configured to selectively coact with interface 30 (e.g. fastener 36) as to allow or prevent the movement of support 60. According to an alternative embodiment, the fastener assembly may be configured to coact with the support and the base directly.

Support 60 may further comprise a second retainer assembly 100. As shown in FIGS. 1, 11 and 12, second retainer assembly 100 may be adjusted to provide additional support to object 12. Second retainer assembly 100 may be adjusted to engage or coact with a portion of object 12 (e.g., engage or coact with a tire, wheel, frame or other mounting or support point).

According to one particularly preferred embodiment, second retainer assembly 100 may be attached to support 60 by using a variety of fasteners, such as screws (see FIG. 11), bolts, rivets, welding (see FIG. 6), etc.

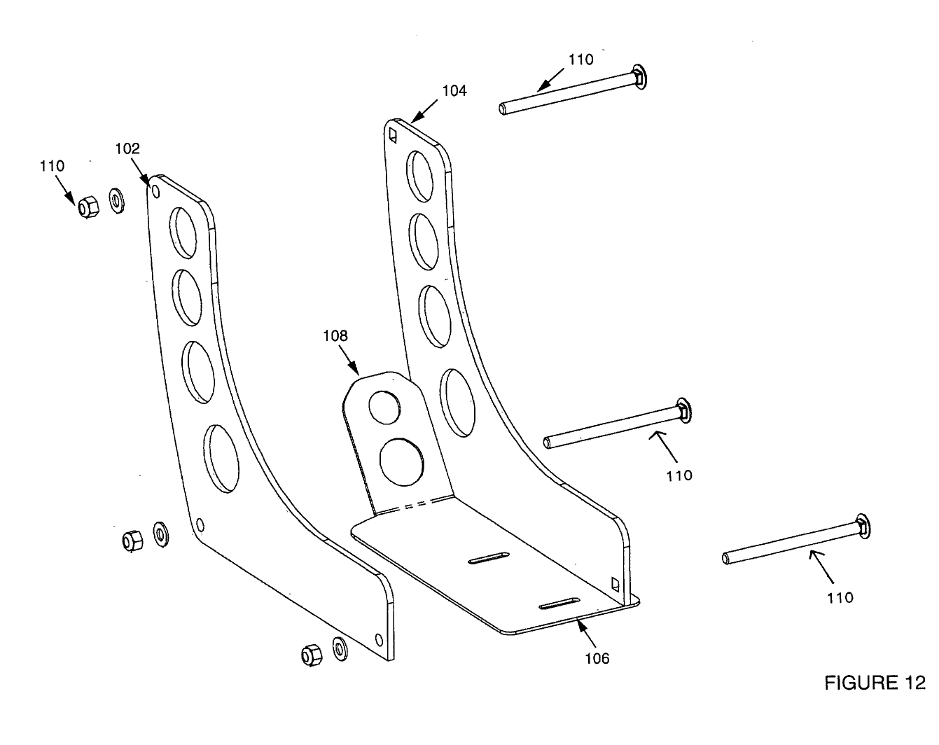

As shown in FIG. 12, second retainer assembly 100 may comprise a first panel 102 and a second panel 104. Panels 102 and 104 may be plates, members, structural members, braces, clamping portions, etc.

Members 102 and 104 may be of sufficient height and width (e.g. two clamp-like brackets or panels) to allow appropriate support of a component of object 12 (such as a tire or wheel). As shown in FIG. 12, panels 102 and 104 are two plates, with fasteners 110 disposed between members 102 and 104. According to one particularly preferred embodiment, fasteners 110 are threaded rods and nuts which allow adjustment in the spacing (e.g. width) of members 102 and 104, thereby allowing members 102 and 104 to engage, coact or clamp with a portion of object 12.

Second retainer assembly 100 may further comprise panel 108. Panel 108 may be configured to stop object 12 as object 12 is placed on merchandising system 10. According to one particularly preferred embodiment, panel 108 is configured to allow for the proper placement of a motorcycle by stopping the front wheel of the motorcycle.

According to various exemplary embodiments, the components of the merchandising system may be made from a variety of materials which provide sufficient strength and rigidity to support and display the object. Such materials may include metals such as steel, steel alloys, aluminum, aluminum alloys, other various metals and alloys, composites, polymers, etc.

In an alternative embodiment, the interface may be provided in the form of an “open” frame or direct mounting to an adapter on the output shaft provided on the motor. In this alternative embodiment, the support may be directly coupled to the motor. According to other alternative embodiments, the mounting structures may have other shapes and/or configurations. According to other alternative embodiments, the base may be a stationary (e.g. non-rotating) base such as a frame, bracket, shelf, or other support structure, or the interface may be installed upon a floor or wall or other “fixed” structure (e.g. without a “base”).

The selective adaptability and/or reconfigurability of the support may advantageously reduce the number of parts required, while providing a “universal” display for use with a plurality of different vehicles and/or frame configurations (e.g. the support may provide an interface for securing any of a variety of products or categories of objects that may have differing frame configurations or support points or may provide multiple support points or options for a single object or single type of objects).

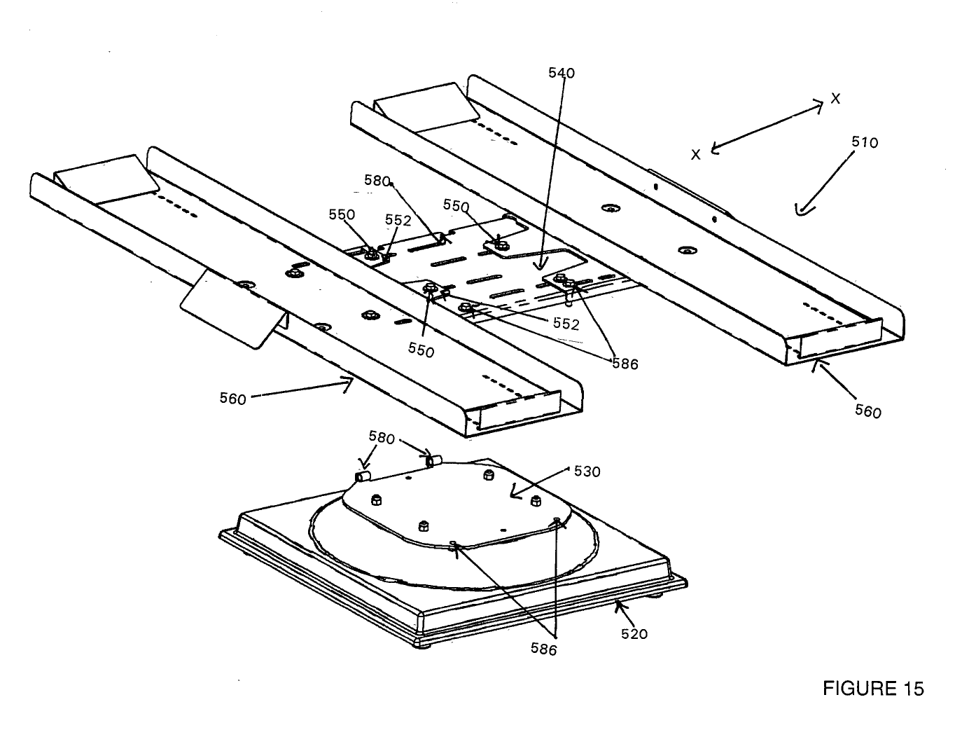

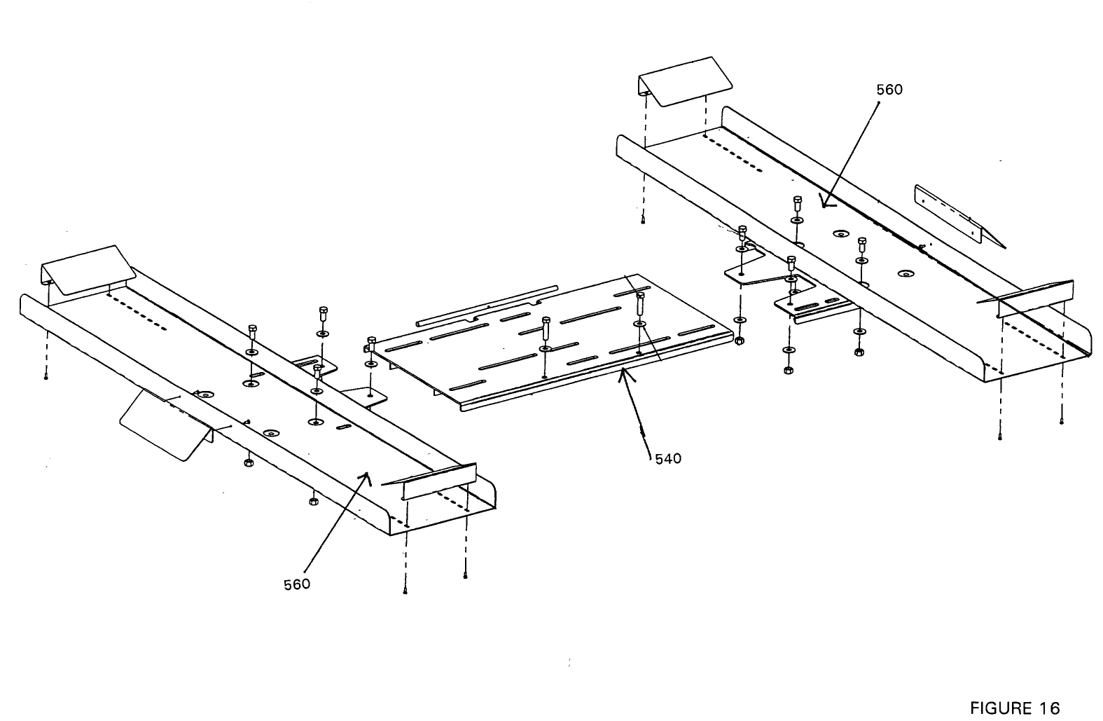

According to one alternative embodiment, the merchandising system may be modified to permit the mounting of multiple ramps as to permit the simultaneous display, static and rotational, of multiple products (e.g., two or more motorcycles), or to permit the display, static and rotational, of products that require more than one ramp for support (e.g., an automobile, a truck, a three-wheel vehicle, etc.). For example, as shown in FIGS. 15 and 16, two supports 560 may be provided with merchandising system 510. Supports 560 are coupled to interface 530. Supports 560 are configured to be adjustable with respect to each other and with respect to base 520. The adjustable nature of supports 560 allows merchandising system 510 to accommodate variously-sized objects (including vehicles of different widths). As shown in FIG. 15, supports 560 are configured to be moved or adjusted in a direction along axis X-X. Fasteners 550 may be moved along slots 552 on plates 540, thereby allowing for adjustment. Pivot assembly 580 and fastener assembly 586 may be configured to allow for the movement of support 560 relative to base 520 as described above. According to one alternative embodiment, supports 560 may be individually coupled to base 520 as to allow for the independent movement of each support (e.g. plate 540 may be omitted and two supports 560 may be coupled individually to interface 530).

It is also important to note that the construction and arrangement of the elements of the merchandising system as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts (e.g., ramp, interfaces, supports, etc.) or elements show as multiple parts may be integrally formed, the operation of the interfaces may be reversed or otherwise varied, the length or width of the structures and/or members or connectors or other elements of the system may be varied, the nature or number of adjustment positions provided between the elements may be varied, the nature and path of movement of the support may be altered or varied (e.g. rotate, eccentric motion, cam-action movement, raising and lowering the support, etc.) method steps may be altered, varied or reversed, etc. It should be noted that the elements and/or assemblies of the system may be constructed from any of a wide variety of materials that provide sufficient strength or durability, in any of a wide variety of colors, textures and combinations. It should also be noted that the merchandising system may be used in association with a rotating display, or alternatively other, fixed and non-movable displays or any of a wide variety of other surfaces in any of a wide variety of other applications. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

What is claimed is:

1. A merchandising system for a vehicle, the merchandising system comprising:
a base;
a member coupled to the base and configured to support the vehicle and configured to move between a first position and a second position;
wherein the first position is configured to allow placement of the vehicle on the member and the second position is configured to display the vehicle.

2. The merchandising system of claim 1 wherein the member comprises a support.

3. The merchandising system of claim 1 wherein the member comprises a ramp.

4. The merchandising system of claim 1 wherein the member is configured to pivot relative to the base.

5. The merchandising system of claim 4 further comprising a pivot assembly provided between the base and the member.

6. The merchandising system of claim 5 wherein the pivot assembly comprises a hinge.

7. The merchandising system of claim 5 wherein the pivot assembly comprises:
a first sleeve coupled to the base;
a second sleeve coupled to the support; and
a pin coupling the first sleeve and the second sleeve.

8. The merchandising system of claim 4 further comprising a fastener assembly configured to selectively prevent movement of the member.

9. The merchandising system of claim 8 wherein the fastener assembly comprises a lock.

10. The merchandising system of claim 8 wherein the fastener assembly comprises one of a screw and a bolt.

11. The merchandising system of claim 8 wherein the fastener assembly comprises a pin.

12. The merchandising system of claim 1 further comprising an interface provided between the base and the member.

13. The merchandising system of claim 12 wherein the interface comprises a plate.

14. The merchandising system of claim 1 further comprising a first fastener configured to couple the vehicle to the merchandising system.

15. The merchandising system of claim 14 wherein the first fastener comprises a web.

16. The merchandising system of claim 15 wherein the web comprises a strap.

17. The merchandising system of claim 1 wherein placement of the vehicle comprises installation of the vehicle.

18. The merchandising system of claim 1 wherein the member is configured to be rotated relative the base.

19. The merchandising system of claim 18 further comprising a drive system, wherein the drive system is configured to rotate the member relative to the base.

20. The merchandising system of claim 19 wherein the drive system further comprises a motor.

21. The merchandising system of claim 19 wherein the drive system further comprises one of a drive assembly and a transmission.

22. The merchandising system of claim 1 further comprising feet provided on the base.

23. The merchandising system of claim 1 wherein the member in the first position is a lowered portion.

24. The merchandising system of claim 1 comprising a third position between the first position and the second position, wherein the third position is configured to allow further placement of the vehicle on the member.

25. The merchandising system of claim 1 further comprising a second fastener configured to secure a portion of the vehicle to the merchandising system.

26. The merchandising system of claim 25 wherein the second fastener comprises a first plate and a second plate.

27. The merchandising system of claim 26 wherein the first plate and the second plate are configured to move relative to each other.

28. The merchandising system of claim 25 wherein the portion of the vehicle is one of a tire, a frame, and a wheel of the vehicle.

29. The merchandising system of claim 25 wherein the second fastener comprises a clamp.

30. The merchandising system of claim 1 wherein the member further comprises a plurality of apertures.

31. The merchandising system of claim 30 further comprising a cross member configured to be received in at least one aperture of the plurality of apertures.

32. The merchandising system of claim 31 further comprising a strap configured to be coupled to the cross member.

33. A merchandising system for displaying a vehicle in an environment having a floor, the system comprising:
a base;
a first ramp coupled to the base;
wherein the first ramp is configured to move between a first position having a portion of the first ramp near the floor and a second position having the portion of the first ramp removed from the floor.

34. The merchandising system of claim 33 wherein the first ramp is configured to rotate relative to the base.

35. The merchandising system of claim 33 further comprising a pivot assembly provided between the base and the first ramp, wherein the first ramp is configured to pivot between the first position and the second position.

36. The merchandising system of claim 33 further comprising a second ramp coupled to the base.

37. The merchandising system of claim 36 wherein the first ramp and the second ramp are configured to move between the first position and the second position.

38. A merchandising system for a vehicle on a floor, the merchandising system comprising:
means for supporting the vehicle;
wherein the means for supporting the vehicle is configured to move between a first position to allow for the placement of the vehicle on the means for supporting the vehicle and a second position to allow for the display of the vehicle.

39. The merchandising system of claim 38 wherein the means for supporting the vehicle is configured to rotate the vehicle.

40. The merchandising system of claim 38 wherein the means for supporting the vehicle is configured to pivot between the first position and the second position.

41. The merchandising system of claim 38 further comprising means for selectively securing the means for supporting the vehicle in the second position.

42. The merchandising system of claim 38 further comprising first means for securing a first portion of the vehicle to the merchandising system.

43. The merchandising system of claim 42 further comprising second means for securing a second portion of the vehicle to the merchandising system.
